(19) United States
(12) Patent Application Publication
(10) Pub. No.: US 2014/0114665 A1
(43) Pub. Date: Apr. 24, 2014

(54) KEYWORD VOICE ACTIVATION IN VEHICLES

(71) Applicant: Carlo Murgia, Sunnyvale, CA (US)

(72) Inventor: Carlo Murgia, Sunnyvale, CA (US)

(21) Appl. No.: 14/058,138

(22) Filed: Oct. 18, 2013

Related U.S. Application Data
(60) Provisional application No. 61/716,042, filed on Oct. 19, 2012.
(60) Provisional application No. 61/716,025, filed on Oct. 19, 2012.
(60) Provisional application No. 61/716,037, filed on Oct. 19, 2012.
(60) Provisional application No. 61/716,337, filed on Oct. 19, 2012.
(60) Provisional application No. 61/716,399, filed on Oct. 19, 2012.

(51) Int. Cl. G10L 21/06; H04R 3/00

(52) U.S. Cl. CPC G10L 21/06; H04R 3/002
USPC 704/275

(57) ABSTRACT

Systems and methods for keyword voice activation in vehicles are provided. In one example, a system comprises one or more microphones, a voice monitoring device, and an automatic speech recognition (ASR) system. The voice monitoring device can receive an acoustic signal from the microphones. A noise in the acoustic signal is reduced or suppressed to obtain a clean speech component. The ASR system may detect one or more keywords in the clean speech component and provide a command associated with the one or more keywords to vehicle systems. The system can associated a profile with the one or more keywords. The profile can include parameters specific to one operator or a group of operators. The parameters associated with the operator's profile can be used in the noise suppression, identification of the operator, and/or detecting keywords in the clean speech component.

### CROSS-REFERENCE TO RELATED APPLICATIONS

This application claims the benefit of the U.S. Provisional Application No. 61/716,042, filed Oct. 19, 2012, U.S. Provisional Application No. 61/716,025, filed Oct. 19, 2012, U.S. Provisional Application No. 61/716,037, filed Oct. 19, 2012, U.S. Provisional Application No. 61/716,337, filed Oct. 19, 2012, and U.S. Provisional Application No. 61/716,399, filed Oct. 19, 2012. The subject matter of the aforementioned applications is incorporated herein by reference for all purposes to the extent such subject matter is not inconsistent herewith or limiting hereof.

### FIELD

The present application relates generally to acoustic signal processing and more specifically to systems and methods for keyword voice activation in vehicles.

### BACKGROUND

Vehicles are mobile machines used to transport passengers and cargo. Vehicles can operate on land, sea, air, and in space. Vehicles, for example, may include cars and other automobiles, trucks, trains, monorails, ships, airplanes, gliders, helicopters, and spacecraft. Vehicle operators, e.g. a driver, a pilot, and so forth can occupy specific areas of the vehicle, for example, a driver's seat, a cockpit, a bridge, and the like. Passengers and/or cargo may occupy other areas of the vehicle, for example, a passenger's seat, a back seat, a trunk, a passenger car, a freight car, a cargo hold, and the like.

Vehicles typically provide enclosed acoustic environments. A car, a cockpit, and a bridge may have windows to offer a wide angle of view. The floors, ceilings, roofs, dashboard, and upholstery of the car, cockpit, bridge, and so forth are comprised of certain materials.

Vehicles can experience noises arising from their operation and the environments in which they operate, for example all of the following can create noise: a road, a track, a tire, a wheel, a fan, a wiper blade, an engine, exhaust, an entertainment system, a communications system, competing speakers, wind, rain, waves, other vehicles, exterior, and the like. The noise experienced in a vehicle may interfere with the hearing, sensing, or detecting of spoken commands. For example, voice commands directed to or otherwise associated with devices in the vehicle, like a navigation system, telematics, mobile telephone, stereo, and so forth or outside the vehicle, e.g. cloud computing, may not be properly understood. Known systems do not provide robust voice activation in noise environments. Since safe operation of a vehicle may be facilitated by reducing distractions such as, for example, looking at a display, pressing buttons, or entering information on a touch screen, hands-free operation may contribute to vehicle's safety.

### SUMMARY

This summary is provided to introduce a selection of concepts in a simplified form that are further described below in the Detailed Description. This summary is not intended to identify key features or essential features of the claimed subject matter, nor is it intended to be used as an aid in determining the scope of the claimed subject matter.

A system for keyword voice activation in vehicles may comprise at least one or more microphones, a voice monitoring device, and an automatic speech recognition (ASR) system. In some embodiments, the microphones can be mounted inside the vehicle, while in other embodiments the microphones can be installed in a car key, key fob, watch, or other wearable device.

In some embodiments, the voice monitoring device can be configured to receive, via the one or more microphones, an acoustic signal. A noise in the acoustic signal may be reduced or suppressed to obtain a clean speech (voice) component.

In some embodiments, the ASR system may be configured to detect one or more keywords in the clean speech component and provide a command associated with the keywords to one or more vehicle systems. The vehicle systems may include communications systems, entertainment systems, climate control systems, navigation system, engine, and other.

In some embodiments, the ASR system may be further configured to associate, with the one or more keywords, an operator's profile. The operator's profile can belong to a single operator or a group of operators frequently using the vehicle, for example a family or a small company. Parameters can be associated with the operator's profile. In some embodiments, the parameters can include typical settings used by the operator to set up control parameters of various vehicle systems. The parameters associated with operator's profile can be stored in internal or external memory or downloaded via a computer network. The parameters can be provided by the operator or measured by the ASR system.

In some embodiments, the parameters associated with the operator's profile can contain information related to the environment in a vehicle which may affect the acoustic signal detection by microphones. The parameters may include a distance between the microphones, distances from the microphones to a source of a voice, a seat position, primary voice frequencies, and others. In some embodiments the environment parameters may be provided to voice monitoring system to be used in noise suppression.

In some embodiments, the parameters associated with the operator's profile can be used by the ASR system when detecting a keyword in the clean speech component.

### BRIEF DESCRIPTION OF THE DRAWINGS

Embodiments are illustrated by way of example and not limitation in the figures of the accompanying drawings, in which like references indicate similar elements and in which:

FIG. 1 is a system for keyword voice activation in vehicles, according to an example embodiments

FIG. 2 is a block diagram of a voice monitoring device, according to an example embodiment.

FIG. 3 is a block diagram of an audio processing system, according to an example embodiment.

FIG. 4 is a block diagram of an automatic speech recognition system, according to an example embodiment.

FIG. 5 is a schematic illustrating steps of a method for keyword voice activation in a vehicle, according to an example embodiment.

FIG. 6 is an example of a computing system implementing a system of keyword voice activation in vehicles.

### DETAILED DESCRIPTION

The present disclosure provides example systems and methods for keyword voice activation in vehicles. Embodiments of the present disclosure may be practiced in automobiles or other vehicles.

According to an example embodiment, a system for keyword voice activation in vehicles can comprise one or more microphones, voice monitoring device, and automatic speech recognition (ASR) system. In some embodiments, the voice monitoring device can be configured to receive an acoustic signal and suppress a noise in the acoustic signal to obtain a clean speech component. In some embodiments, the ASR system can be configured to detect one or more keywords in the clean speech component and provide a command associated with the one or more keywords to one or more vehicle systems.

In certain embodiments, the ASR system can associate a profile with the one or more keywords, the profile being associated either with a single operator or a plurality of operators. In some embodiments, the parameters associated with the operator's profile can be provided to the voice monitoring system to be used in the noise suppression. In some embodiments, the parameters associated with the operator's profile can be used by the ASR system when detecting the one or more keywords in the clean speech component.

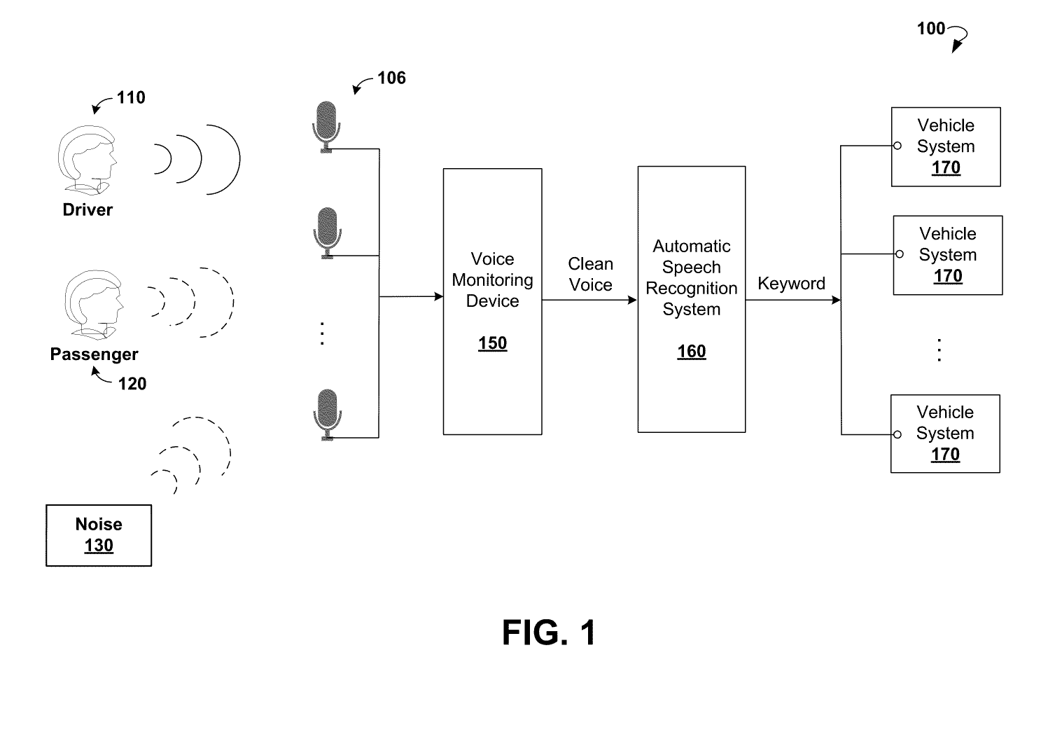

Referring now to FIG. 1, an example system 100 for keyword voice activation in vehicles is shown. In some embodiments, the system 100 may comprise a voice monitoring device 150, an automatic speech recognition system 160, and one or more vehicle system 170. The electronic voice monitoring device 150 may include one or more microphones 106. The system 100 for keyword voice activation may include more or fewer components than illustrated in FIG. 1, and the functionality of modules may be combined or expanded into fewer or additional modules. Thus, in certain embodiments the system 100 may comprise several voice monitoring devices 150 and several automatic speech recognition system 160. In other embodiments, the electronic voice monitoring device 150 or automatic speech recognition system 160 may be incorporated in vehicle system 170.

Microphones 106 may be used to detect both spoken communication, for example, voice commands from the driver 110 or the passenger 120 or other operator and the noise 130 experienced inside the vehicle. In some embodiments, some microphones may be used mainly to detect speech and other microphones may be used mainly to detect noise. In other embodiments, some microphones may be used to detect both noise and speech.

Acoustic signals detected by the microphones 106 may be used to separate speech from the noise by the voice monitoring device 150. Strategic placement of the microphones may substantially contribute to the quality of noise reduction. High quality noise reduction, for example, may produce clean speech that is very close to the original speech. Microphones directed towards detecting speech from a certain speaker, driver or passenger, may be disposed in relatively close proximity to the speaker. In some embodiments, two or more microphones may be directed towards the speaker. In further embodiments, two or more microphones may be positioned in relatively close proximity to each other.

In some embodiments of the system 100, one or more voice monitoring devices 150 may be configured to monitor continuously for speech acoustic signals from one or more microphones 106 and to remove the noise from the received acoustic signals. In other embodiments, one or more voice monitoring devices 150 may be activated selectively based on input, for example, from a voice activity detector.

Clean speech may be obtained via the voice monitoring device 150 which may be part of (or separate from in some embodiments) an automatic speech recognition (ASR) system 160. The ASR system 160 may provide recognized speech, for example, a recognized voice command, to one or more vehicle systems 170. The vehicle systems 170 may include one or more of a communications system, an entertainment system, a climate control system, a navigation system, an engine, and the like. In some embodiments, the ASR system 160 may be separated from and communicatively coupled with the one or more vehicle systems 170. In other embodiments, the ASR system 160 may be, at least partially, incorporated into the one or more vehicle systems.

In some embodiments, the one or more vehicle systems 170 may be configured and/or activated in response to certain recognized speech, a recognized voice command including, but not limited to, one or more keywords, or key phrases. The associated keywords and other voice commands may be pre-programmed into the one or more vehicle systems 170 or selected by an operator.

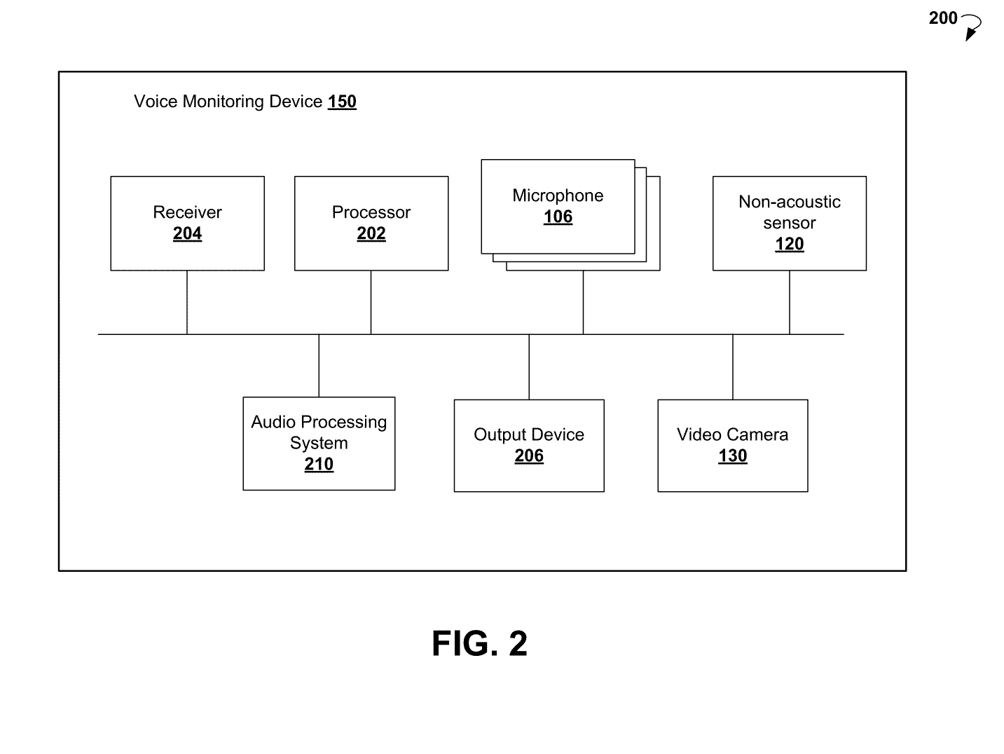

FIG. 2 is a block diagram of an example voice monitoring device 150. In example embodiments, the voice monitoring device 150 (also shown in FIG. 1) may include a processor 202, a receiver 204, one or more microphones 106 (also shown in FIG. 1), an audio processing system 210, an optional non-acoustic sensor 120, an optional video camera 130, and an output device 206. In operation, the voice monitoring device 150 may comprise additional or different components. Similarly, voice monitoring device 150 may comprise fewer components that perform functions similar or equivalent to those depicted in FIG. 2.

Still referring to FIG. 2, the processor 202 may include hardware and/or software, which may execute computer programs stored in a memory (not shown in FIG. 2). The processor 202 may use floating point operations, complex operations, and other operations, including noise reduction or suppression in received acoustic signal.

The optional non-acoustic sensor 120 may measure a spatial position of a sound source, such as the mouth of a main talker (also referred to as “Mouth Reference Point” or MRP). The optional non-acoustic sensor 120 may also measure a distance between the one or more microphones 106 (or voice monitoring device 150) and a sound source. The optional non-acoustic sensor 120 may also measure relative position of the one or more microphones 106 (or voice monitoring device 150) and a sound source. In either case, the optional non-acoustic sensor 120 can generate positional information, which may then be provided to the processor 202 or stored in a memory (not shown).

The video camera 130 may be configured to capture still or motion images of an environment, from which the acoustic signal is captured. The images captured by the video camera 130 may include pictures taken within the visible light spectrum or within a non-visible light spectrum such as the infrared light spectrum (also referred to as “thermal vision” images). The video camera 130 may generate a video signal of the environment, which may include one or more sound sources (e.g., talkers) and optionally one or more noise sources (e.g., other talkers and operating machines). The video signal may be transmitted to the processor 202 for storing in a memory (not shown) or processing to determine relative position of one or more sound sources.

The audio processing system 210 may be configured to receive acoustic signals from an acoustic source via the one or more microphones 106 and process the acoustic signals' components. The microphones 106 (if multiple microphones 106 are utilized) may be spaced a distance apart such that acoustic waves impinging on the device from certain directions exhibit different energy levels at the two or more microphones. After reception by the microphones 106, the acoustic signals may be converted into electric signals. These electric signals may themselves be converted by an analog-to-digital converter (not shown) into digital signals for processing in accordance with some embodiments.

In some embodiments, the microphones 106 are omni-directional microphones closely spaced (e.g., 1-2 cm apart), and a beamforming technique may be used to simulate a forward-facing and a backward-facing directional microphone response. Alternatively embodiments may utilize other forms of microphones or acoustic sensors. A level difference may be obtained using the simulated forward-facing and the backward-facing directional microphone. According to various embodiment, the level difference between (at least) two microphones may be used to discriminate speech and noise in, for example, the time-frequency domain, which can be used in noise and/or echo reduction. In other embodiments, the microphones 106 are directional microphones, which may be arranged in rows and oriented in various directions.

In certain embodiments, the acoustic signal may be provided to voice monitoring device 150 via receiver 204. For example, one or more microphones may be placed in car key, key fob, watch, or other wearable device. The acoustic signal may be converted to an audio signal and transmitted to the voice monitoring device 150 by a radio channel, Bluetooth, infrared, or the like.

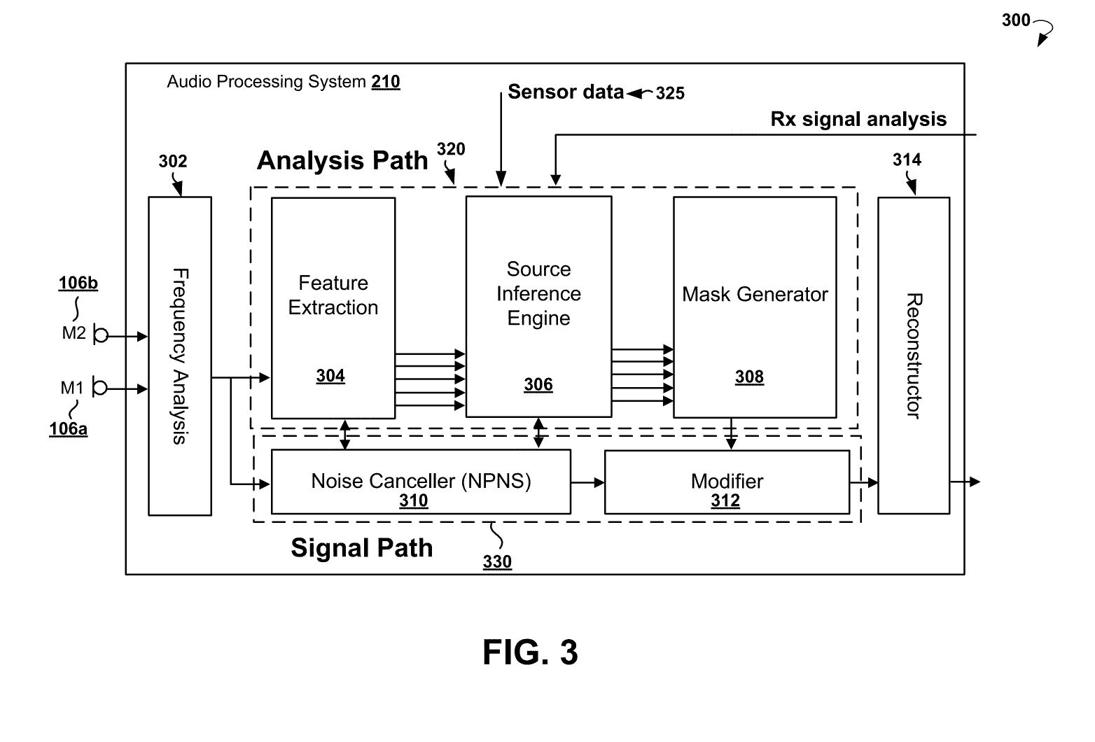

FIG. 3 is a block diagram of an example audio processing system 210. In example embodiments, the audio processing system 210 (also shown in FIG. 2) may be embodied in a memory device disposed inside the voice monitoring device 150 (shown in FIG. 2). The audio processing system 210 may include a frequency analysis module 302, a feature extraction module 304, a source inference engine module 306, a mask generator module 308, noise canceller (Null Processing Noise Subtraction or NPNS) module 310, modifier module 312, and reconstructor module 314. Descriptions of these modules are provided below.

The audio processing system 210 may include more or fewer components than illustrated in FIG. 3, and the functionality of modules may be combined or expanded into fewer or additional modules. Example lines of communication are illustrated between various modules of FIG. 3, and in other figures herein. The lines of communication are not intended to limit which modules are communicatively coupled with other modules, nor are they intended to limit the number of and type of signals between modules.

Data provided by non-acoustic sensor 120 (FIG. 2) may be used in audio processing system 210, for example, by analysis path sub-system 320. This is illustrated in FIG. 3 by sensor data 325, which may be provided by the non-acoustic sensor 120, leading into the analysis path sub-system 320.

In the audio processing system of FIG. 3, acoustic signals received from a primary microphone 106a and a secondary microphone 106b (in this example, two microphones 106 are shown for clarity, other number of microphones may be used) may be converted to electrical signals, and the electrical signals may be processed by frequency analysis module 302. In one embodiment, the frequency analysis module 302 may receive the acoustic signals and mimic the frequency analysis of the cochlea (e.g., cochlear domain), simulated by a filter bank. The frequency analysis module 302 may separate each of the primary and secondary acoustic signals into two or more frequency sub-band signals. A sub-band signal is the result of a filtering operation on an input signal, where the bandwidth of the filter is narrower than the bandwidth of the signal received by the frequency analysis module 302. Alternatively, other filters such as a short-time Fourier transform (STFT), sub-band filter banks, modulated complex lapped transforms, cochlear models, wavelets, and so forth can be used for the frequency analysis and synthesis.

Because most sounds (e.g. acoustic signals) are complex and include more than one frequency, a sub-band analysis of the acoustic signal may determine what individual frequencies are present in each sub-band of the complex acoustic signal during a frame (e.g. a predetermined period of time). For example, the duration of a frame may be 4 ms, 8 ms, or some other length of time. Some embodiments may not use frames at all. The frequency analysis module 302 may provide sub-band signals in a fast cochlea transform (FCT) domain as an output.

Frames of sub-band signals may be provided by frequency analysis module 302 to the analysis path sub-system 320 and to the signal path sub-system 330. The analysis path sub-system 320 may process a signal to identify signal features, distinguish between speech components and noise components of the sub-band signals, and generate a signal modifier. The signal path sub-system 330 may modify sub-band signals of the primary acoustic signal, e.g. by applying a modifier such as a multiplicative gain mask or a filter, or by using subtractive signal components as may be generated in analysis path sub-system 320. The modification may reduce undesired components (i.e. noise) and preserve desired speech components (i.e. main speech) in the sub-band signals.

Noise suppression can use gain masks multiplied against a sub-band acoustic signal to suppress the energy levels of noise (i.e. undesired signal) components in the subband signals. This process may also be referred to as multiplicative noise suppression. In some embodiments, acoustic signals can be modified by other techniques, such as a filter. The energy level of a noise component may be reduced to less than a residual noise target level, which may be fixed or slowly varied over time. A residual noise target level may, for example, be defined as a level at which a noise component is no longer audible or perceptible, below a noise level of a microphone used to capture the acoustic signal, or below a noise gate of a component such as an internal Automatic Gain Control (AGC) noise gate or baseband noise gate within a system used to perform the noise cancellation techniques described herein.

Still referring to FIG. 3, the signal path sub-system 330 within audio processing system 210 may include NPNS module 310 and modifier module 312. The NPNS module 310 may receive sub-band frame signals from frequency analysis module 302. The NPNS module 310 may subtract (e.g., cancel) an undesired component (i.e. noise) from one or more sub-band signals of the primary acoustic signal. As such, the NPNS module 310 may output sub-band estimates of noise components in the primary signal and sub-band estimates of speech components in the form of noise-subtracted sub-band signals.

The NPNS module 310 within signal path sub-system 330 may be implemented in a variety of ways. In some embodiments, the NPNS module 310 may be implemented as a single NPNS module. Alternatively, the NPNS module 310 may include two or more NPNS modules, which may be arranged for example in a cascade fashion. The NPNS module 310 can provide noise cancellation for multi-microphone configurations, for example based on source location, by utilizing a subtractive algorithm. The NPNS module 310 can also provide echo cancellation. Since noise and echo cancellation can usually be achieved with little or no voice quality degradation, processing performed by the NPNS module 310 may result in an increased signal-to-noise-ratio (SNR) in the primary acoustic signal received by subsequent post-filtering and multiplicative stages, some of which are shown elsewhere in FIG. 3. The amount of noise cancellation performed may depend on the diffuseness of the noise source and the distance between microphones. These both contribute towards the coherence of the noise between the microphones, with greater coherence resulting in better cancellation by the NPNS module.

An example of null processing noise subtraction performed in some embodiments by the NPNS module 310 is described in U.S. Utility patent application Ser. No. 12/422,917, entitled “Adaptive Noise Cancellation,” filed Apr. 13, 2009, which is incorporated herein by reference.

Noise cancellation may be based on null processing, which involves cancelling an undesired component in an acoustic signal by attenuating audio from a specific direction, while simultaneously preserving a desired component in an acoustic signal, e.g. from a target location such as a main talker. The desired audio signal may include a speech signal. Null processing noise cancellation systems can determine a vector that indicates the direction of the source of an undesired component in an acoustic signal. This vector is referred to as a spatial “null” or “null vector.” Audio from the direction of the spatial null may be subsequently reduced. As the source of an undesired component in an acoustic signal moves relative to the position of the microphone(s), a noise reduction system can track the movement, and adapt and/or update the corresponding spatial null accordingly.

An example of a multi-microphone noise cancellation system which may perform null processing noise subtraction (NPNS) is described in U.S. Utility patent application Ser. No. 12/215,980, entitled “System and Method for Providing Noise Suppression Utilizing Null Processing Noise Subtraction,” filed Jun. 30, 2008, which is incorporated herein by reference. Noise subtraction systems can operate effectively in dynamic conditions and/or environments by continually interpreting the conditions and/or environment and adapting accordingly.

Information from the non-acoustic sensor 120 may be used to control the direction of a spatial null in the noise canceller 310. In particular, the non-acoustic sensor information may be used to direct a null in an NPNS module or a synthetic cardioid system based on positional information provided by the non-acoustic sensor 120. An example of a synthetic cardioid system is described in U.S. Utility patent application Ser. No. 11/699,732, entitled “System and Method for Utilizing Omni-Directional Microphones for Speech Enhancement,” filed Jan. 29, 2007, which is incorporated herein by reference.

In a two-microphone system, coefficients σ and α may have complex values. The coefficients may represent the transfer functions from a primary microphone signal (P) to a secondary (S) microphone signal in a two-microphone representation. However, the coefficients may also be used in an N microphone system. The goal of the σ coefficient(s) is to cancel the speech signal component captured by the primary microphone from the secondary microphone signal. The cancellation can be represented as S-σP. The output of this subtraction is an estimate of the noise in the acoustic environment. The α coefficient can be used to cancel the noise from the primary microphone signal using this noise estimate. The ideal σ and α coefficients can be derived using adaptation rules, wherein adaptation may be necessary to point the σ null in the direction of the speech source and the α null in the direction of the noise.

In adverse SNR conditions, it may become difficult to keep the system working optimally, i.e. optimally cancelling the noise and preserving the speech. In general, since speech cancellation is an undesirable action, the system may be tuned in order to minimize speech loss. Even with the conservative tuning, noise leakage may occur.

As an alternative, a spatial map of the σ (and potentially α) coefficients can be created in the form of a table, comprising one set of coefficients per valid position. Each combination of coefficients may represent a position of the microphone(s) of the communication device relative to the MRP and/or a noise source. From the full set entailing all valid positions, an optimal set of values can be created, for example using the LBG algorithm. The size of the table may vary depending on the computation and memory resources available in the system. For example, the table could contain u and a coefficients describing all possible positions of the phone around the head. The table could then be indexed using three-dimensional and proximity sensor data.

Still referring to FIG. 3, the analysis path sub-system 320 may include the feature extraction module 304, source interference engine module 306, and mask generator module 308. The feature extraction module 304 may receive the sub-band frame signals derived from the primary and secondary acoustic signals provided by frequency analysis module 302. Furthermore, feature extraction module 304 may receive the output of NPNS module 310. The feature extraction module 304 may compute frame energy estimations of the sub-band signals, an inter-microphone level difference (ILD) between the primary acoustic signal and the secondary acoustic signal, and self-noise estimates for the primary and second microphones. The feature extraction module 304 may also compute other monaural or binaural features for processing by other modules, such as pitch estimates and cross-correlations between microphone signals. Furthermore, the feature extraction module 304 may provide inputs to and process outputs from the NPNS module 310, as indicated by a double-headed arrow in FIG. 3.

The feature extraction module 304 may compute energy levels for the sub-band signals of the primary and secondary acoustic signal and an inter-microphone level difference (ILD) from the energy levels. The ILD may be determined by feature extraction module 304. Determining energy level estimates and inter-microphone level differences is discussed in more detail in U.S. Utility patent application Ser. No. 11/343,524, entitled “System and Method for Utilizing Inter-Microphone Level Differences for Speech Enhancement,” filed Jan. 30, 2006, which is incorporated herein by reference.

Non-acoustic sensor information may be used to configure a gain of a microphone signal as processed, for example by the feature extraction module 304. Specifically, in multi-microphone systems that use ILD as a source discrimination cue, the level of the main speech decreases as the distance from the primary microphone to the MRP increases. If the distance from all microphones to the MRP increases, the ILD of the main speech decreases, resulting in less discrimination between the main speech and the noise sources. Such corruption of the ILD cue may typically lead to undesirable speech loss. Increasing the gain of the primary microphone modifies the ILD in favor of the primary microphone. This results in less noise suppression, but improves positional robustness.

Another part of analysis path sub-system 320 is source inference engine module 306, which may process frame energy estimates to compute noise estimates, and which may derive models of the noise and speech from the sub-band signals. The frame energy estimate processed in source interference engine module 306 may include the energy estimates of the output of the frequency analysis 302 and of the noise canceller 310. The source inference engine module 306 may adaptively estimate attributes of the acoustic sources. The energy estimates may be used in conjunction with speech models, noise models, and other attributes, estimated in source interference engine module 306, to generate a multiplicative mask in mask generator module 308.

Still referring to FIG. 3, the source inference engine module 306 may receive the ILD from feature extraction module 304 and track the ILD-probability distributions or “clusters” of sound coming from a speech of the driver 110 and, optionally, of passenger 120, noise 130, and, optionally, echo. When the source and noise ILD-probability distributions are non-overlapping, it is possible to specify a classification boundary or dominance threshold between the two distributions. The classification boundary or dominance threshold may be used to classify an audio signal as speech if the ILD is sufficiently positive or as noise if the ILD is sufficiently negative. The classification may be determined per sub-band and time frame and used to form a dominance mask as part of a cluster tracking process.

The classification may additionally be based on features extracted from one or more non-acoustic sensors 120, and as a result, the audio processing system may exhibit improved positional robustness. The source interference engine module 306 may perform an analysis of sensor data 325, depending on which system parameters are intended to be modified based on the non-acoustic sensor data.

The source interference engine module 306 may provide the generated classification to the NPNS module 310, and may utilize the classification to estimate noise in NPNS output signals. A current noise estimate along with locations in the energy spectrum are provided for processing a noise signal within the audio processing system 210. Tracking clusters are described in U.S. Utility patent application Ser. No. 12/004,897, entitled “System and Method for Adaptive Classification of Sound Sources,” filed Dec. 21, 2007, the disclosure of which is incorporated herein by reference.

The source inference engine module 306 may generate an ILD noise estimate and a stationary noise estimate. In one embodiment, the noise estimates can be combined with a max( ) operation, so that the noise suppression performance resulting from the combined noise estimate is at least that of the individual noise estimates. The ILD noise estimate can be derived from the dominance mask and the output of NPNS module 310.

For a given normalized ILD, sub-band, and non-acoustical sensor information, a corresponding equalization function may be applied to the normalized ILD signal to correct distortion. The equalization function may be applied to the normalized ILD signal by either the source inference engine 306 or the mask generator 308.

The mask generator module 308 of the analysis path sub-system 320 may receive models of the sub-band speech components and/or noise components as estimated by the source inference engine module 306. Noise estimates of the noise spectrum for each sub-band signal may be subtracted from the energy estimate of the primary spectrum to infer a speech spectrum. The mask generator module 308 may determine a gain mask for the sub-band signals of the primary acoustic signal and provide the gain mask to the modifier module 312. The modifier module 312 can multiply the gain masks and the noise-subtracted sub-band signals of the primary acoustic signal output by the NPNS module 310, as indicated by the arrow from NPNS module 310 to the modifier module 312. Applying the mask reduces the energy levels of noise components in the sub-band signals of the primary acoustic signal and thus accomplishes noise reduction.

Values of the gain mask output from mask generator module 308 may be time-dependent and sub-band-signal-dependent, and may optimize noise reduction on a per sub-band basis. Noise reduction may be subject to the constraint that the speech loss distortion complies with a tolerable threshold limit. The threshold limit may be based on many factors. Noise reduction may be less than substantial when certain conditions, such as unacceptably high speech loss distortion, do not allow for more noise reduction. In various embodiments, the energy level of the noise component in the sub-band signal may be reduced to less than a residual noise target level. In some embodiments, the residual noise target level is substantially the same for each sub-band signal.

The reconstructor module 314 may convert the masked frequency sub-band signals from the cochlea domain back into the time domain. The conversion may include applying gains and phase shifts to the masked frequency sub-band signals adding the resulting signals. Once conversion to the time domain is completed, the synthesized acoustic signal may be provided to the user via the output device 206 and/or provided to a codec for encoding.

In some embodiments, additional post-processing of the synthesized time domain acoustic signal may be performed. For example, comfort noise generated by a comfort noise generator may be added to the synthesized acoustic signal prior to providing the signal to the user. Comfort noise may be a uniform constant noise that is not usually discernible by a listener (e.g., pink noise). This comfort noise may be added to the synthesized acoustic signal to enforce a threshold of audibility and to mask low-level non-stationary output noise components. In some embodiments, the comfort noise level may be chosen to be just above a threshold of audibility and/or may be settable by a user.

In some embodiments, noise may be reduced in acoustic signals received by the audio processing system 210 by a system that adapts over time. Audio processing system 210 may perform noise suppression and noise cancellation using initial values of parameters, which may be adapted over time based on information received from the non-acoustic sensor 120, acoustic signal processing, and a combination of non-acoustic sensor 120 information, and acoustic signal processing.

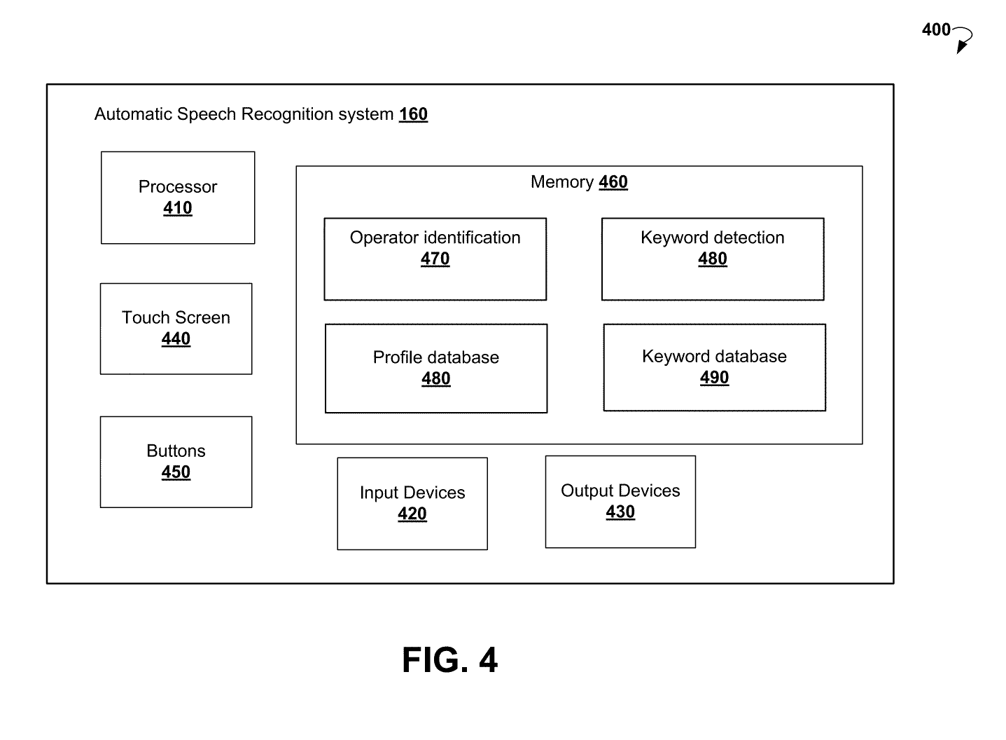

FIG. 4 is a block diagram illustrating automatic speech recognition (ASR) system 160 according to an example embodiment. The ASR system 160 may comprise a processor 410, a memory 460, input devices 420, output devices 430, optional buttons 450, and an optional touchscreen 440. In operation, the ASR system 160 may comprise additional or different components. Similarly, the ASR system 160 may comprise fewer components that perform functions similar or equivalent to those depicted in FIG. 4.

The processor 410 may use floating point operations, complex operations, and other operations. The processor may be configured to execute applications stored in memory 460 to perform different functions of the ASR system. The applications stored in the memory 460 may include an operator identification 470 and keyword detection 480.

In some embodiments, the ASR system 160 may be configured to receive, via the input devices 420, a clean speech from the voice monitoring device and process the clean speech, by the processor 410, following instructions of one of applications stored in the memory 460. In some embodiments, the clean speech may be processed with a keyword detection application to identify a specific keyword or key phrase. In some embodiments, pre-determined keywords may be stored in keyword database 490 in the memory 460. In other embodiments, keyword database 490 may be stored in external memory device or be provided to the ASR system 160 via network from a cloud. The pre-determined keywords may be obtained by training, when an operator provides several samples of voice to be associated with a particular keyword. In certain embodiments, some of the samples of voice may be provided when the operator is wearing mask or has a cold, or may have the operator's usual voice altered in some way. The process may, in some embodiments, be configured to adapt so at to recognize speech having such variations in the operator's voice as originating from the operator.

In some embodiments, each keyword or key phrase may be associated with a command for one or more of the vehicle systems 170 (shown in FIG. 1). Once a specific keyword is detected the command associated with keyword may be provided to one of the vehicle systems via output devices 430. Example methods and systems for keyword detection using a voice command are described in U.S. provisional application 61/836,977, titled “Adapting a Text-Derived Model for Voice Sensing and Keyword Detection,” filed Jun. 19, 2013.

In some embodiments, the operator (e.g. driver 110 or passenger 120) may provide the identification information to ASR system 160 by providing input using a button 450 or a switch (not shown), entering information via the touchscreen 440. In some embodiments, the operator may provide the identification information by a sample voice command. An example systems for authentication of operator by a sample voice command are described in U.S. Provisional Patent Application No. 61/826,900, titled “Voice Sensing and Keyword Analysis,” filed on May 23, 2013, which is incorporated herein by reference. In some embodiments, alternatively or additionally, the identification information may be provided via a car key, a key fob, and the like on or proximate to the operator's person.

In some embodiments, the one or more ASR systems 160 may associate a profile with an operator in response to identifying the operator. The profile may be unique to a certain operator and/or shared by a plurality of operators. The profile may include parameters. Parameters may be associated with noise reduction and control of the acoustic environment of the vehicle. Parameters may be determined by sensing, measuring or calculating or provided by the operator to one or more vehicle systems: communications systems, entertainment systems, climate control systems, navigation system, engine, and the like. In certain embodiments the profiles may be associated with voice samples provided to ASR system 160 during training for detection of keywords. In some embodiments, the profiles may be stored in profile database 480 in the memory 460. In other embodiments the profile database may be stored on an external memory device or may be downloaded via a wireless network from a cloud.

In further embodiments, the one or more vehicle systems 170 (shown in FIG. 1) may be configured using the parameters in response to a profile being associated with the operator. In some embodiments, the parameters associated with noise reduction, e.g., parameters which control or influence the operation of one or more parts of the noise reduction system, such as filters and noise in the vehicle acoustic environment may be customized for a specific operator or operators. In some embodiments, parameters may include the distance between the microphones and an audio source such as an operator's mouth, seat position, primary voice frequencies, typical interior and exterior noises frequently encountered by the operator or otherwise associated with the operator, and the like. In certain embodiments, parameters associated with operator's profiles may include a typical volume setting for a car stereo and/or a volume to which the car stereo will be automatically set when the operator speaks, e.g., begins a communication session such as a call or issues a voice command.

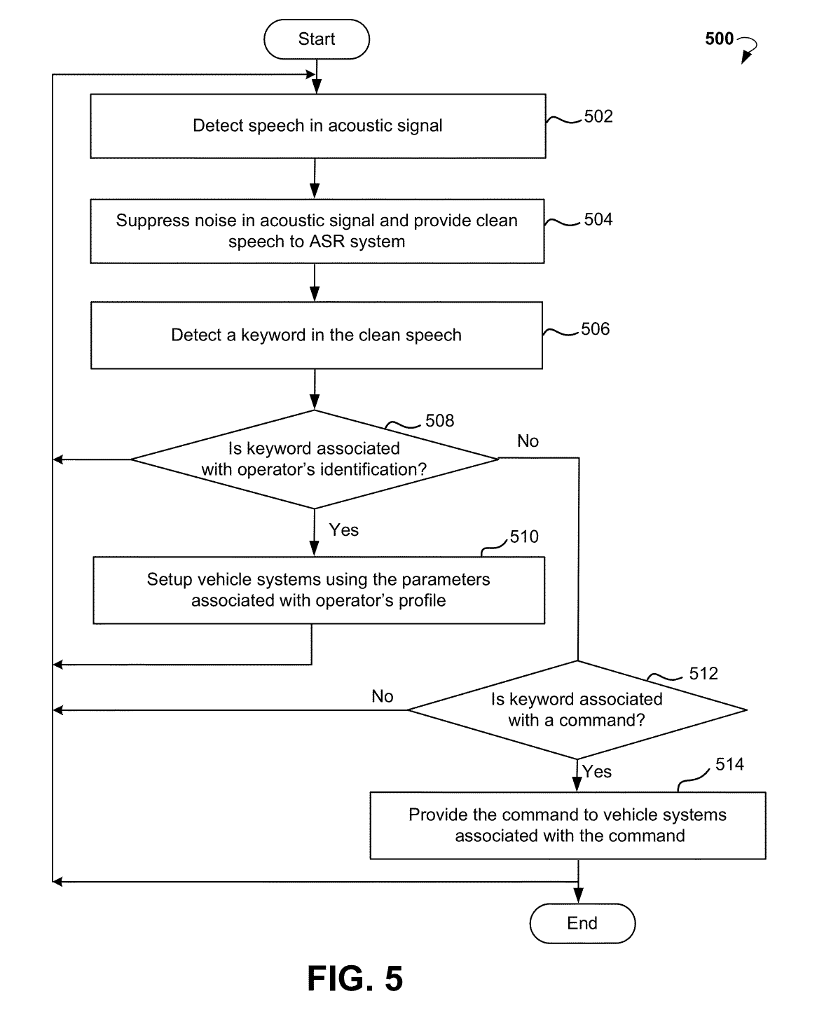

FIG. 5 is a flow chart for illustrating steps of a method 500 for keyword voice activation in vehicles. The steps of the method 500 may be carried using the system 100 for keyword voice activation shown in FIG. 1. In step 502, an acoustic signal inside a may be monitored by the voice monitoring device 150 (shown in FIG. 1 and FIG. 2) to detect speech in the acoustic signal. In step 504, once a speech component in the acoustic signal is recognized, the suppression of noise in the acoustic signal may be carried out to obtain a clean speech and the clean speech may be provided to the ASR system 160. The step 504 may be performed by audio processing system 210 of the voice monitoring device 150 (shown in FIG. 2). In step 506, a keyword may be detected. In step 508, a test can be carried out to determine whether the keyword is associated with operator's identification. If the keyword is associated with identification of operator, in step 510, the vehicle systems may be set up using the parameters associated with the operator's user profile. In step 512, a test can be carried out to determine whether the keyword is associated with a command. If the keyword is associated with a command, the command is provided to vehicle systems associated with the command. The steps 506-512 may be performed with the ASR system 160 shown in FIG. 1 and FIG. 2. In some embodiments of the example method 500 illustrated in FIG. 5, some steps may be combined, performed in parallel, or performed in a different order. In other embodiments, the method 500 may include additional or fewer steps than those illustrated.

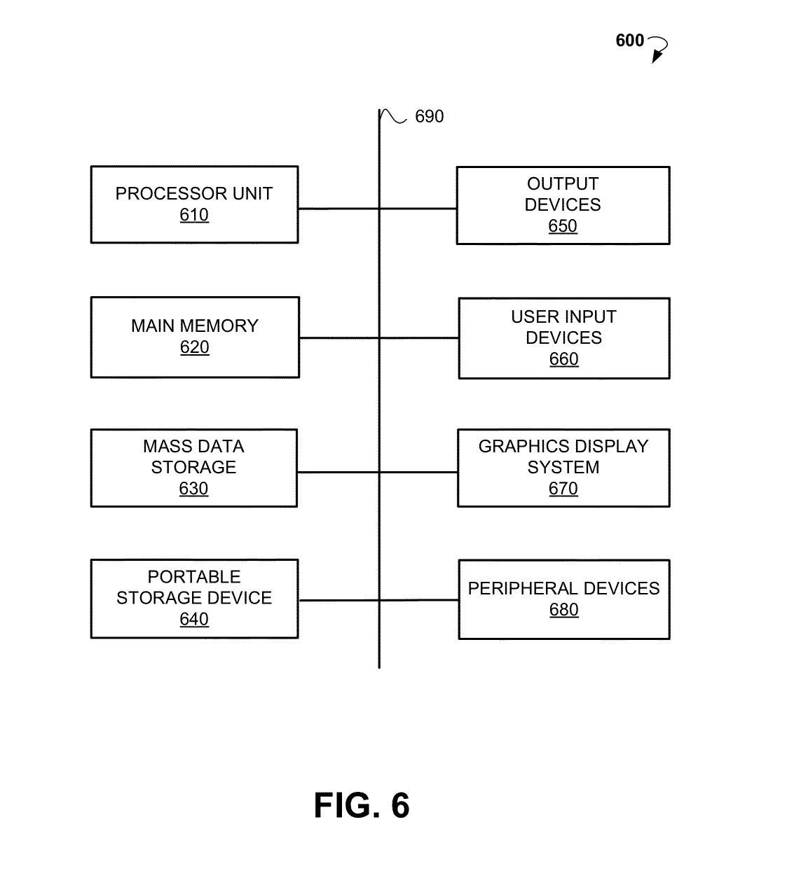

FIG. 6 illustrates an example computing system 600 that may be used to implement embodiments of the present disclosure. The computing system 600 of FIG. 6 may be implemented in the contexts of the likes of computing systems, networks, servers, or combinations thereof. The computing system 600 of FIG. 6 includes one or more processor units 610 and main memory 620. Main memory 620 stores, in part, instructions and data for execution by processor unit 610. Main memory 620 may store the executable code when in operation. The computing system 600 of FIG. 6 further includes a mass storage device 630, portable storage device 640, output devices 650, user input devices 1160, a graphics display system 670, and peripheral devices 680.

The components shown in FIG. 6 are depicted as being connected via a single bus 690. The components may be connected through one or more data transport means. Processor unit 610 and main memory 620 may be connected via a local microprocessor bus, and the mass storage device 630, peripheral device(s) 680, portable storage device 640, and graphics display system 670 may be connected via one or more input/output (I/O) buses.

Mass storage device 630, which may be implemented with a magnetic disk drive or an optical disk drive, is a non-volatile storage device for storing data and instructions for use by processor unit 610. Mass storage device 630 may store the system software for implementing embodiments of the present disclosure for purposes of loading that software into main memory 620.

Portable storage device 640 operates in conjunction with a portable non-volatile storage medium, such as a floppy disk, compact disk, digital video disc, or Universal Serial Bus (USB) storage device, to input and output data and code to and from the computing system 600 of FIG. 6. The system software for implementing embodiments of the present disclosure may be stored on such a portable medium and input to the computing system 600 via the portable storage device 640.

Input devices 660 provide a portion of a user interface. Input devices 660 may include one or more microphones, an alphanumeric keypad, such as a keyboard, for inputting alphanumeric and other information, or a pointing device, such as a mouse, a trackball, stylus, or cursor direction keys. Input devices 660 may also include a touchscreen. Additionally, the computing system 600 as shown in FIG. 6 includes output devices 650. Suitable output devices include speakers, printers, network interfaces, and monitors.

Graphics display system 670 may include a liquid crystal display (LCD) or other suitable display device. Graphics display system 670 receives textual and graphical information and processes the information for output to the display device.

Peripheral devices 680 may include any type of computer support device to add additional functionality to the computer system. Peripheral device(s) 680 may include a GPS navigation device, telematics device (e.g., OnStar), entertainment device GSM modem, satellite radio, router, and the like.

The components provided in the computing system 600 of FIG. 6 are those typically found in computer systems that may be suitable for use with embodiments of the present disclosure and are intended to represent a broad category of such computer components that are well known in the art. Thus, the computing system 600 of FIG. 6 may be a personal computer (PC), hand held computing system, telephone, mobile computing system, workstation, server, minicomputer, mainframe computer, or any other computing system. The computer may also include different bus configurations, networked platforms, multi-processor platforms, and the like. Various operating systems may be used including UNIX, LINUX, WINDOWS, MAC OS, CHROME, ANDROID, IOS, QNX, and other suitable operating systems.

It is noteworthy that any hardware platform suitable for performing the processing described herein is suitable for use with the embodiments provided herein. Computer-readable storage media refer to any medium or media that participate in providing instructions to a central processing unit (CPU), a processor, a microcontroller, or the like. Such media may take forms including, but not limited to, non-volatile and volatile media such as optical or magnetic disks and dynamic memory, respectively. Common forms of computer-readable storage media include a floppy disk, a flexible disk, a hard disk, magnetic tape, any other magnetic storage medium, a Compact Disk Read Only Memory (CD-ROM) disk, digital video disk (DVD), BLU-RAY DISC (BD), any other optical storage medium, Random-Access Memory (RAM), Programmable Read-Only Memory (PROM), Erasable Programmable Read-Only Memory (EPROM), Electronically Erasable Programmable Read Only Memory (EEPROM), flash memory, and/or any other memory chip, module, or cartridge.

In some embodiments, the computing system 600 may be implemented as a cloud-based computing environment, such as a virtual machine operating within a computing cloud. In other embodiments, the computing system 600 may itself include a cloud-based computing environment, where the functionalities of the computing system 600 are executed in a distributed fashion. Thus, the computing system 600, when configured as a computing cloud, may include pluralities of computing devices in various forms, as will be described in greater detail below.

In general, a cloud-based computing environment is a resource that typically combines the computational power of a large grouping of processors (such as within web servers) and/or that combines the storage capacity of a large grouping of computer memories or storage devices. Systems that provide cloud-based resources may be utilized exclusively by their owners or such systems may be accessible to outside users who deploy applications within the computing infrastructure to obtain the benefit of large computational or storage resources.

The cloud may be formed, for example, by a network of web servers that comprise a plurality of computing devices, such as the computing device 150, with each server (or at least a plurality thereof) providing processor and/or storage resources. These servers may manage workloads provided by multiple users (e.g., cloud resource customers or other users). Typically, each user places workload demands upon the cloud that vary in real-time, sometimes dramatically. The nature and extent of these variations typically depends on the type of business associated with the user.

While the present embodiments have been described in connection with a series of embodiments, these descriptions are not intended to limit the scope of the subject matter to the particular forms set forth herein. It will be further understood that the methods are not necessarily limited to the discrete components described. To the contrary, the present descriptions are intended to cover such alternatives, modifications, and equivalents as may be included within the spirit and scope of the subject matter as disclosed herein and defined by the appended claims and otherwise appreciated by one of ordinary skill.

What is claimed is:

1. A method for keyword voice activation in a vehicle, the method comprising:
receiving, via one or more microphones, an acoustic signal;
suppressing noise in the acoustic signal to produce a clean speech component;
detecting one or more keywords in the clean speech component; and
providing a command associated with the one or more keywords to one or more vehicle systems.

2. The method of claim 1, wherein the one or more microphones comprise at least two microphones rigidly mounted inside the vehicle.

3. The method of claim 1, wherein the one or more microphones are installed in a wearable device.

4. The method of claim 1 further comprising:
associating a profile with the one or more keywords;
receiving parameters associating with the profile; and
configuring the one or more vehicle system using the parameters.

5. The method of claim 4, wherein the profile is associated with a single operator.

6. The method of claim 4, wherein the suppressing noise in the acoustic signal is based on the parameters associated with the profile.

7. The method of claim 4, wherein the detecting the one or more keywords in the clean speech component is based on the parameters associated with the profile.

8. The method of claim 4, wherein the parameters associated with the profile comprise:
a distance between the microphones;
distances between the microphones and a source of a voice;
a seat position; and
primary voice frequencies.

9. The method of claim 4, wherein the profile is associated with an operator of the vehicle and parameters are provided by the operator.

10. The method of claim 4, wherein the profile is associated with an operator and the parameters include primary voice frequencies associated with the operator.

11. A system for keyword voice activation in a vehicle, the system comprising
one or more microphones;
a voice monitoring device, the voice monitoring being configured to:
receive, via the one or more microphones, an acoustic signal;
suppress noise in the acoustic signal to obtain a clean speech component; and
provide the obtained clean speech component to an automatic speech recognition system, the automatic speech recognition system being configured to detect one or more keywords in the clean speech component; and provide a command associated with the one or more keywords to one or more vehicle systems.

12. The system of claim 11, wherein the automatic speech recognition system is coupled with the one or more vehicle systems.

13. The system of claim 11, wherein the automatic speech recognition system is incorporated into the one or more vehicle systems.

14. The system of claim 11, wherein the automatic speech recognition system is separate from the voice monitoring device.

15. The system of claim 11, wherein the one or more microphones comprise at least two microphones rigidly mounted inside the vehicle.

16. The system of claim 11, wherein the one or more microphones are installed in a wearable device.

17. The system of claim 11, the system being further configured to:
associate a profile with the one or more keywords;
receive parameters associated with the profile, the parameters being for configuring the one or more vehicle systems.

18. The system of claim 17, wherein the profile is associated with a single operator or group of operators.

19. The system of claim 17, wherein the voice monitoring device is configured to suppress the noise based on the parameters associated with the profile.

20. The system of claim 17, wherein the system is configured to provide for detection of the one or more keywords in the clean speech component based on the parameters associated with the profile.

21. The system of claim 17, wherein the parameters associated with the profile comprise:
a distance between the microphones;
distances between the microphones and a source of a voice;
a seat position; and
primary voice frequencies associated with an operator.

22. The system of claim 17, wherein the profile is associated with an operator of the vehicle and parameters are provided by the operator.

23. The system of claim 17, wherein the profile is associated with an operator and the parameters include primary voice frequencies associated with the operator.

24. A non-transitory machine readable medium having embodied thereon a program, the program providing instructions for a method for keyword voice activation in a vehicle, the method comprising:
receiving, via one or more microphones, an acoustic signal;
suppressing noise in the acoustic signal to obtain a clean speech component; and
providing the obtained clean speech component to an automatic speech recognition system, the automatic speech recognition system being configured to detect one or more keywords in the clean speech component and provide a command associated with the one or more keywords to one or more vehicle systems.
